(19) United States
(12) Patent Application Publication
(10) Pub. No.: US 2018/0032747 A1
(43) Pub. Date: Feb. 1, 2018

(54) System and Method for Database-Level Access Control Using Rule-Based Derived Accessor Groups

(71) Applicant: Siemens Product Lifecycle Management Software Inc., Plano, TX (US)

(72) Inventor: John Staehle Whelan, White Bear Lake, MN (US)

(21) Appl. No.: 15/222,210

(22) Filed: Jul. 28, 2016

(51) Int. Cl. G06F 21/62; G06F 17/30

(52) U.S. Cl. CPC G06F 21/6218; G06F 17/30424; G06F 17/30339

(57) ABSTRACT

A system and method is provided that facilitates database-level access control using rule-based derived accessor groups. The system may comprise a database including a plurality of object data records for which user access rules are stored in the database via a plurality of derived accessor groups associated with each object data record. The database may store definitions of each derived accessor group in tables that specify both positive relationships and negative relationships between the derived accessor groups and primitive user groups. Such primitive user groups may be associated with users that have membership in the primitive user groups. The positive relationships specify primitive user groups that have memberships in particular derived accessor groups. Also the negative relationships specify primitive user groups that are not permitted membership in particular derived accessor groups. The definitions of the derived groups may be stored in the database so as to enable lookup of derived group memberships from primitive user group memberships for a user in a same single SQL query that is performed to access only object data records from the database for which the derived accessor groups specify that the user has permission to access.

### TECHNICAL FIELD

The present disclosure is directed, in general, to computer-aided design (CAD), computer-aided manufacturing (CAM), computer-aided engineering (CAE), visualization, simulation, and manufacturing systems, product data management (PDM) systems, product lifecycle management (PLM) systems, and similar systems, that are used to create, use, and manage data for products and other items (collectively referred to herein as product systems).

### BACKGROUND

Product systems may be used to manage product data in databases using rule-based access control. Such product systems may benefit from improvements.

### SUMMARY

Variously disclosed embodiments include data processing systems and methods that may be used to facilitate database-level access control using rule-based derived accessor groups. In one example, a system may comprise a database including a plurality of object data records for which user access rules are stored in the database via a plurality of derived accessor groups associated with each object data record. The database may store definitions of each derived accessor group in tables that specify both positive relationships and negative relationships between the derived accessor groups and primitive user groups. Such primitive user groups may be associated with users that have membership in the primitive user groups. The positive relationships may specify primitive user groups that have memberships in particular derived accessor groups. The negative relationships may specify primitive user groups that are not permitted membership in particular derived accessor groups. The definitions of the derived groups may be stored in the database so as to enable lookup of derived group memberships from primitive user group memberships for a user in a same single SQL query that is performed to access only object data records from the database for which the derived accessor groups specify that the user has permission to access.

In another example, a method for database-level access control using rule-based derived accessor groups may comprise through operation of at least one processor an act of receiving a search query for searching for object data records in a database including a plurality of object data records for which user access rules are stored in the database via a plurality of derived accessor groups associated with each object data record. The database may store definitions of each derived accessor group in tables that specify both positive relationships and negative relationships between the derived accessor groups and primitive user groups. Such primitive user groups may be associated with users that have membership in the primitive user groups. The positive relationships may specify primitive user groups that have memberships in particular derived accessor groups. The negative relationships may specify primitive user groups that are not permitted membership in particular derived accessor groups. In addition the method may comprise through operation of the at least one processor an act of looking up derived group memberships from primitive user group memberships for a user in a same single SQL query that is performed to access only object data records from the database for which the derived accessor groups specify that the user has permission to access.

A further example may include a non-transitory computer readable medium encoded with executable instructions (such as a software component on a storage device) that when executed, causes at least one processor to carry out this described method.

Another example may include an apparatus including at least one hardware, software, and/or firmware based processor, computer, controller, means, module, and/or unit configured to carry out functionality corresponding to this described method.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the Detailed Description below, it should be understood that various definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

FIG. 1 illustrates a functional block diagram of an example system that facilitates database-level access control using rule-based derived accessor groups.

FIG. 2 illustrates a set of user access rules that define user access permissions for an object data record.

FIG. 3 illustrates derived accessor groups determined from user access rules.

FIG. 4 illustrates relationships that define derived accessor groups with respect to primitive user groups.

FIG. 5 illustrates a single SQL query usable to retrieve only business object records for which a user has permissions to access based on derived accessor groups.

FIG. 6 illustrates a flow diagram of an example methodology that facilitates database-level access control using rule-based derived accessor groups.

FIG. 7 illustrates a block diagram of a data processing system in which an embodiment may be implemented.

### DETAILED DESCRIPTION

Various technologies that pertain to systems and methods that facilitate database-level access control using rule-based derived accessor groups will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

Verifying that requesting users have access rights is an important aspect of information management systems, including product systems, and can consume significant time and system resources. In the realm of access checking, a system that has simple access rules (i.e., users or groups directly referenced by data records) can have minimal performance impact due to rules checking because simple granting rules can be implemented via security checks which are included as part of initial queries to databases, a process referred to herein as “mapped security”, as opposed to post-query filtering.

However, simple access rights that allow for high-performance operations may not be sufficient for the security needs of enterprise information systems. Enterprise information systems may have a need for relatively more complex rules for access that can include both granting and denying rules, precedence in rules, and compound rules. Post-query filtering, for example, may be used to enforce such relatively more complex rules.

Disclosed example embodiments may be used to replace post-query filter using complex rules with a form that can obtain the performance characteristics of a system that only contains simple access rights while supporting both mapped security and complex access rights rules.

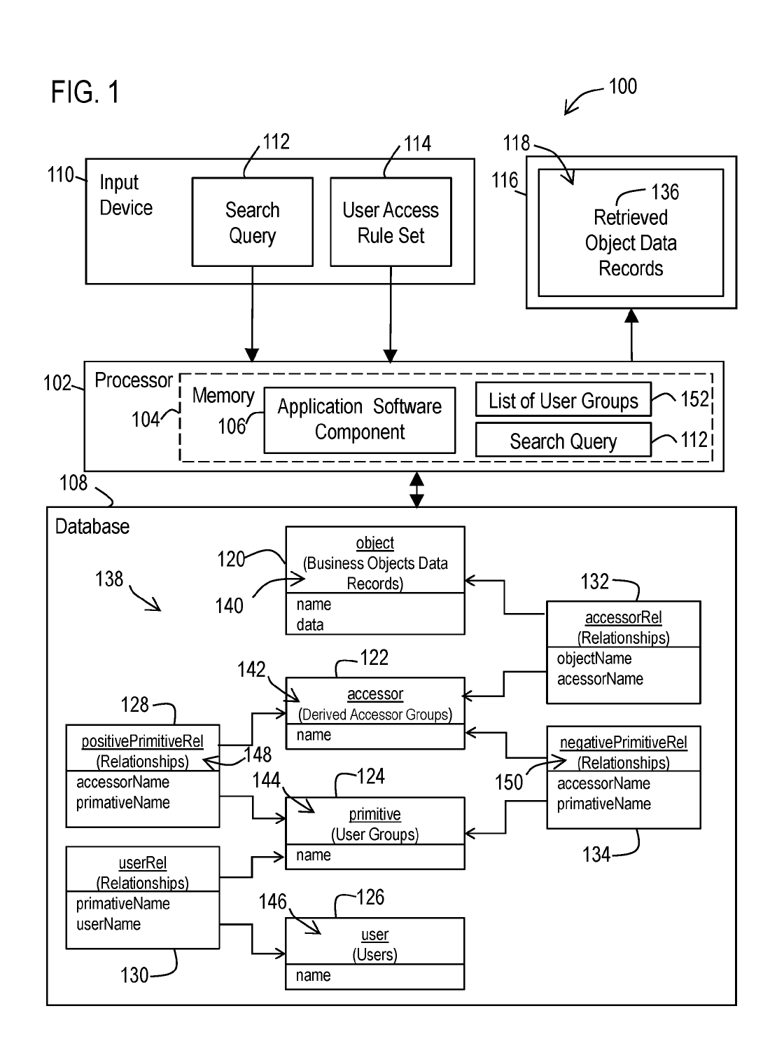

With reference to FIG. 1, an example data processing system 100 is illustrated that facilitates database-level access control using rule-based derived accessor groups. The system 100 may include at least one processor 102 that is configured to execute at least one application software component 106 from a memory 104 accessed by the processor. The application software component may be configured (i.e., programmed) to cause the processor to carry out various acts and functions described herein. For example, the described application software component 106 may include and/or correspond to one or more components of a PLM software application that is configured to retrieve, generate, and store product data in a data store 108 such as a relational database (e.g., Oracle, Microsoft SQL Server).

Examples of PLM software applications that may be adapted to carry out the features and functions described herein may include computer-aided design (CAD) software, computer-aided manufacturing (CAM) software, and computer-aided engineering (CAE) software included in the NX suite of applications as well as the Teamcenter applications produced by Siemens Product Lifecycle Management Software Inc., of Plano Tex. However, it should be appreciated that the systems and methods described herein may be used in other product systems and/or any other type of system that generates and stores data to a database.

The described system may include at least one display device 116 (such as a display screen) and at least one input device 110. For example, the at least one processor may be included as part of a PC, notebook computer, workstation, server, tablet, mobile phone, or any other type of computing system or combination thereof. The display device, for example, may include an LCD display, monitor, and/or a projector. The input devices, for example, may include a mouse, pointer, touch screen, touch pad, drawing tablet, track ball, buttons, keypad, keyboard, game controller, camera, motion sensing device that captures motion gestures, or any other type of input device capable of providing the inputs described herein. Also for devices such as a tablet, the processor 102 may be integrated into a housing that includes a touch screen that serves as both an input and display device. Further, it should be appreciated that some input devices (such as a game controller) may include a plurality of different types of input devices (analog stick, d-pad, and buttons).

In an example embodiment, the application software component may be configured to cause the at least one processor to retrieve data from the database 108 in order to carry out various tasks. For example, a CAD software application may query a database to retrieve a list of parts and associated documents (e.g., CAD drawings). However, the particular user using the software may not have authorization to review all of the parts in the database. The user may have memberships in one or more groups that are given permission to access some parts, but not others. This may be carried out, for example, by having the login Id (or other credential) associated with the user that is assigned membership to one or more groups. Documents such as CAD drawings may then be stored in the database in association with the particular groups that are granted positive permissions to access the drawings. Such documents may also be stored in the database in association with particular groups that are explicitly not permitted to access the CAD drawings (e.g., via negative permissions). For example, a user may be a member of a particular engineering group permitted to access a CAD drawing via positive permission. However, the CAD drawing may have an export classification that prevents it from being exported to one or more countries. This may be enforced by associating a group targeted with users having residence in one or more countries, to the CAD drawing with negative permissions. Thus, even though the user may have membership in the engineering group with associated positive permissions with respect to the CAD drawing, the described system is operative to prevent the user from accessing the CAD drawing in cases where the user is also a member of the group for the one or more countries having the negative permissions with respect to the CAD drawing.

It should be appreciated that rules of varying complexity may be generated for different documents and other types of data stored in a database. As used herein, such data stored in a database that is associated with complex access rules are referred to as object data records. Such object data records may include any type of business objects (including any type of product data) for which different users access the data to carry out their particular job functions using the application software component.

When an object data record (such as for a CAD drawing) is stored in the database 108, A graphical user interface 118, generated by the application software component, may be configured to enable a user to configure a set of access rules that defines access rights to the object data records. Such a GUI may enable the user to select different groups and combine them via Boolean logical expressions such as (AND) and (OR) and to specify positive and negative access rights for the object data record.

Example embodiments of the application software component may also be configured to translate such complex access rules into a form that can be stored in association with the object data records and which enables retrieval of only business records for which a user has permission to access. As used herein, such translated complex user access rules correspond to sets of derived accessor groups, which are derived from more primitive user groups. When an object data record is stored in the database it may also be stored in associated with the derived accessor groups that correspond to the user specified complex access rules.

Subsequently, when another user wishes to access the document, the functionally that determines whether the document is made available to the other user, may be based on a determination that the derived access rules for the document correspond to derived accessor groups for the particular user groups in which the other user has membership.

In the examples described subsequently, such derived accessor groups are also referred to as accessor groups or simply as accessors. Also such user groups are referred to herein as primitive user groups and simply primitives. The examples described herein provide a method of computing a user's current derived accessor group memberships by representing derived accessor group composition through a set of relationships to primitive user group memberships, and a process for quickly traversing those relationships to resolve a user's derived accessor group memberships. By leveraging database-level access control using derived accessor group grant-based access, example embodiments enable an efficient process of obtaining the up-to-date derived accessor group memberships for the user in the same SQL statement that includes a search query for object data records.

In example embodiments, derived accessors groups correspond to algebraic expressions of primitive user groups. Thus, for systems with larger numbers of primitive user groups, computing all possible permutations (all possible derived accessor groups) for a particular user may be prohibitive and result in an undesirably slow access to data object records via post-query filtration using such large numbers of possible derived accessor groups. Given a large number of potential derived accessor groups that can be composed of a user's primitive user groups, the described example embodiments achieve performance and security increases by limiting the calculation of a user's derived accessor group memberships to those derived accessor groups that are actually existing in the system.

Also, each time an object data record (e.g., documents, product data, and business objects) is inserted or updated into the database, the processor may be configured to cause the generation of derived accessor groups based on the combination of primitive user group membership conditions dictated by the governing user access rules specified for the object data records. Thus, it should also be appreciated that the addition of new and updated business objects in the system may be constantly occurring for an actively used system. By calculating a user's derived accessor memberships at query time, the results of the search query returned by example embodiments reflect the current access permission status of the object data records, and minimize the opportunity for a user to access object data records based on outdated access rules.

In example embodiments, derived accessor logic for determining membership in a derived accessor may be in a “Sum of Products” (SoP) two-level canonical form. Using a SoP approach to derive accessor membership, the Boolean expression for a complex user access rule for a given object may be in the form “(AND/NOT) [(OR) (AND/NOT)]*”. In cases where the user access rule includes OR'ed terms, the OR'ed terms may be broken down into different derived accessor groups.

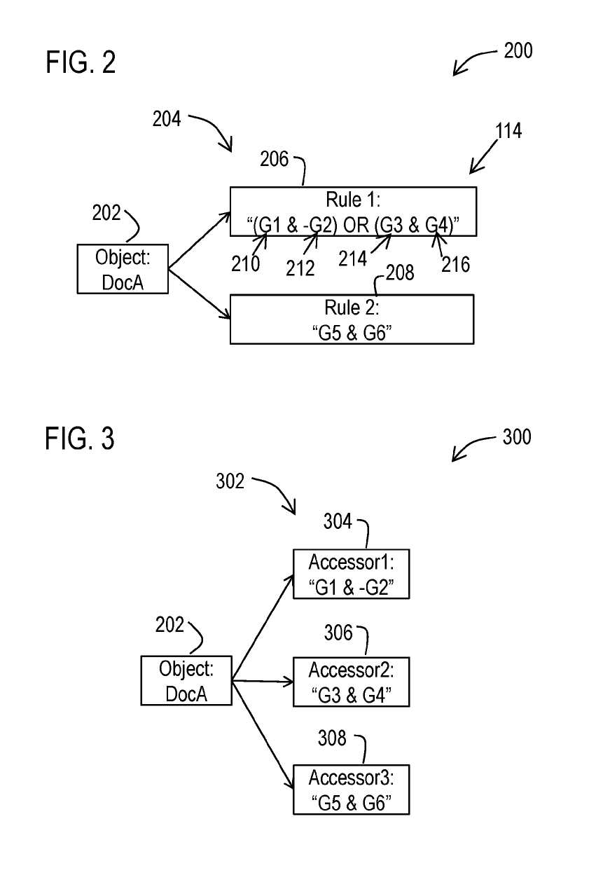

For example, FIG. 2 illustrates an example 200 in which an object data record (DocA) 202 (such as a CAD drawing document) is to be stored or updated in the database 108. The object data record (DocA) 202 is associated with user access permissions 204 in the database based on a received user access rule set 114 comprised of two user access rules (Rule1 & Rule2) 206, 208. Such a complex user access rule set 114 may be received by the processor when the document is initially created and revised or at other times. For example, as illustrated in FIG. 1, a user using the described GUI 118 may provide a user access rule set 114, for a particular document via an input device 110. In another example, one or more parent objects to which the object data record has a parent/child relationship in the database 108 may have been previously stored or updated based on a received user access rule set 114. The user access permissions for the data object (DocA) 202 in FIG. 2 may then be inherited from the parent object(s).

In example embodiments, a rule set may include a combination of granting portions 210 and denying portions 212 for user groups that define access to the at least one object data record. For example, in FIG. 2, the first rule (Rule 1) 206 includes granting and denying terms 210, 212, 214, 216 that indicate that: users in the primitive user group G1 while not being in primitive user group G2, have access permission; or users in both primitive user groups G3 and G4 have access permission. In addition, the second rule (Rule 2) 208 indicates that users in both primitive user groups G5 and G6 have access permission to the object data record (DocA) 202. It should be noted that the negative sign “−” before the second primitive user group (G2) shown in the first rule (Rule 1) 206, corresponds to denying permission by indicating negative group membership. Thus, users in primitive user group G1 that are also in G2, are not granted user access, unless membership in primitive user groups G3 and G4 or G5 and G6 grants them permissions.

In example embodiments, the first rule (Rule 1) 206 may be broken apart at the conjunction (“OR”) into two different portions corresponding to minterms (i.e., AND'ed sets of groups and exclusions). Such mineterms correspond to new derived accessor groups. Thus, as illustrated in the example 300 shown in FIG. 3, by breaking down the first rule (Rule 1) 206 into two different portions, the previously described access rule set 114 may be translated into a set 302 of three separate derived accessor groups 304, 306, 308 (i.e., Accessor1, Accessor2, Accessor3).

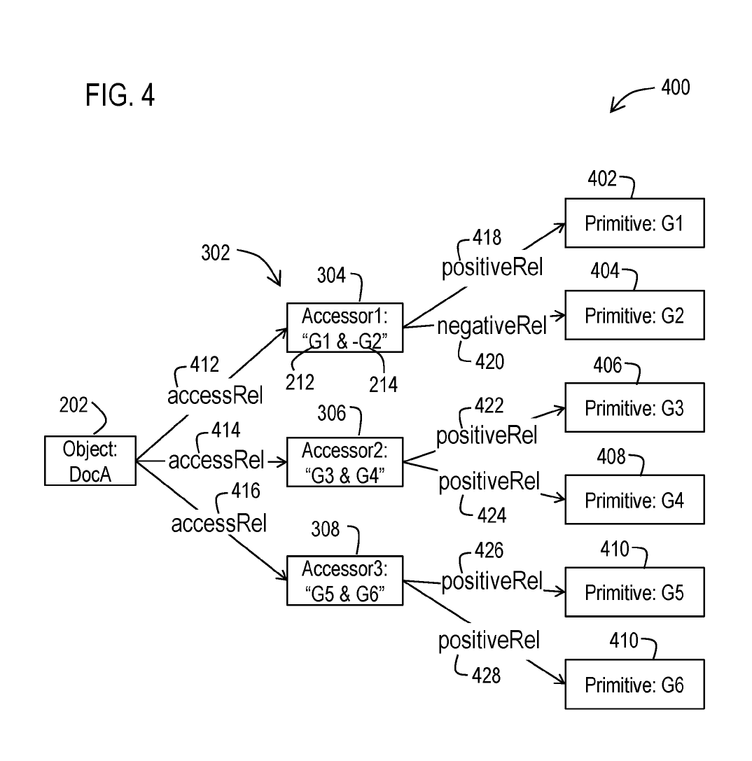

In order to be able to calculate a user's derived user accessor group memberships at query-time (i.e., in the same SQL query as the search query), an example embodiment may populate the database 108 with the primitive user group composition of the derived accessor groups. FIG. 4 illustrates an example 400 of such primitive user group compositions for the examples 200, 300 illustrated in FIGS. 2 and 3.

As illustrated in FIG. 4, there may be two different types of relationships between the derived user access groups (Accessor1 to Accessor3) 304, 306, 308 and the primitive user groups (G1 to G6) 402 to 412. In cases where the primitive user group is part of the granting intersection of the derived accessor group, the relationship is a positive relationship type (positiveRel) 418, 422 to 428. In cases where the primitive user group is omitted from the composition of the derived accessor group, the relationship is a negative relationship type (negativeRel) 420.

In example embodiments, the described positive and negative relationships 418-428 between derived accessor groups and primitive user groups may be stored in the database 108. In addition, in example embodiments, access relationships (accessRel) 412, 414, 416, between object data records 202 and associated derived accessor groups 304, 306, 308 may also be stored in the database 108.

Referring back to FIG. 1, an example database schema 138 is illustrated by which database tables 120 to 134 may be organized in the database 108 to store object data records 140, derived accessor groups 142, primitive user groups 144, users 126, and the relationships 148, 150 therebetween.

One or more object tables 120, for example, may comprise a plurality of object data records 140 for which user access rules 114 are stored in the database via a plurality of derived accessor groups 142 (stored in accessor table 122) associated with such object data records.

Such a schema is configured to store definitions of each derived accessor group in tables 122, 124, 128, 134 that specify both positive relationships 148 and negative relationships 150 between the derived accessor groups in the accessor table 122 and primitive user groups 144 in a primitive table 124. Primitive users groups are associated with users 146 that have membership in the primitive user group. Data records regarding such users may be stored in a user table 126 for example.

In this example, the positive relationships 148 may be stored in a positivePrimitiveRel table 128 which specifies primitive user groups (in the primitive table 124) that have memberships in particular derived accessor groups (in the accessor table 122). Also, the negative relationships 150 may be stored in a negativePrimitiveRel table 134 which specifies primitive user groups (in the primitive table 124) that are not permitted membership in particular derived accessor groups (in the accessor table 122).

As discussed previously, when an object data record (such as a document, CAD drawing, or other product data) is stored or updated in the database 108, the application software component may be configured to generate the applicable derived accessor groups for the document that correspond to the received user access rule set 114 for the document. The processor may also be configured to store/update generated derived access groups as well as applicable primitive user groups in the database in association with the object data record, if not already stored in the database.

In example embodiments, in order for a user to retrieve data from the database for which user access is controlled via the described embodiments, the at least one processor 102 may be configured to receive a search query 112 for searching for particular object data records in the database 108. The search query may specify one or more particular documents to select, update, and/or delete. Also, the search query may specify terms, parameters, wildcards, and/or any other search criteria by which the processor may use to search for and retrieve, update, and/or delete object data records.

In order to limit access of object records to those for which a user (such as a first user) has permissions to access, the at least one processor may also receive a list of primitive user groups 152 in which the first user that is carrying out the search, has membership. Such user primitive user groups, for example, may be retrieved from the primitive table 124 for the first user. Also, the at least one processor may be configured to determine the first user (for which the list of primitive user groups are retrieved) via enabling the first user to provide login information (e.g., a userid, password, token, certificate, pin, and/or other authentication credentials) that identifies and/or corresponds to a particular user record stored in the user table 126.

The at least one processor may then access (e.g., retrieve, update, delete) from the database 108 with a single SQL query, a set of object data records 136 corresponding to the search query 112 for which the first user has permissions to access. Such a single SQL query may be configured to use the received list of primitive user groups 152 to select the set of object data records that are associated with derived accessor groups for which: all user groups related to the derived accessor groups via a positive relationship are included in the received list of primitive user groups; and none of the primitive user groups related to the derived accessor groups via a negative relationship are within the received list of primitive user groups.

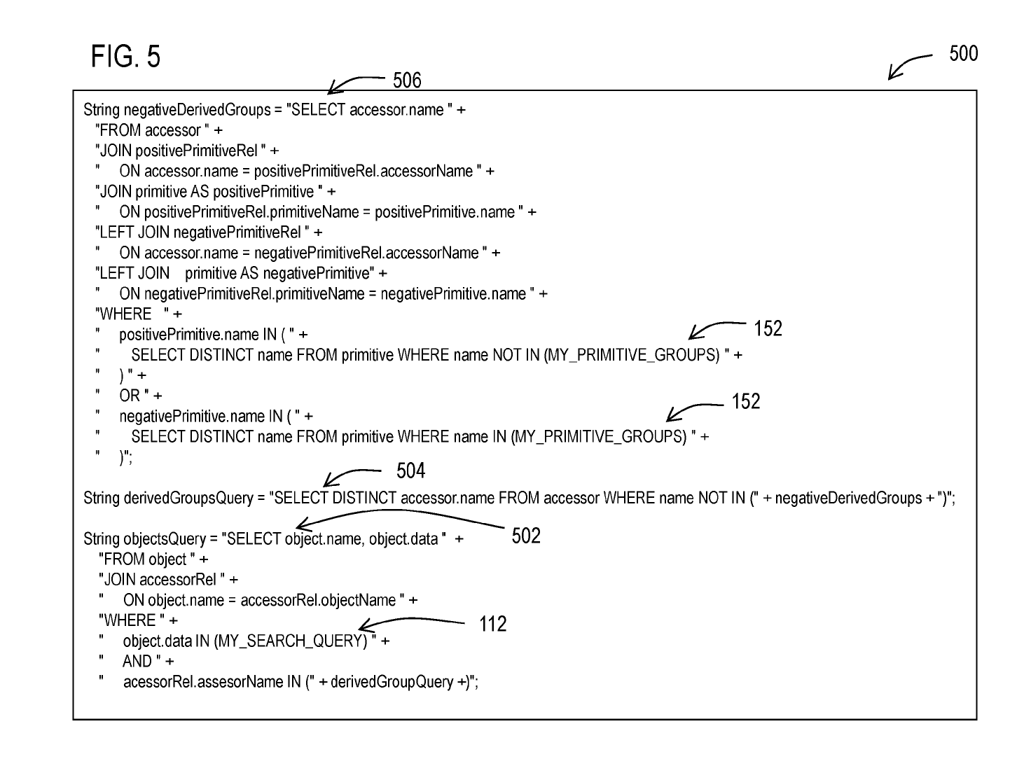

An example of such a single SQL query 500 is illustrated in FIG. 5. In this example, the single SQL query includes a SELECT call 502 based on the received search query for object data records associated with derived accessor groups that are selected based on a further SELECT call 504 included in the single SQL query 500 that specifies the received list of primitive user groups 152.

However, it should be appreciated that the described single SQL query 500 may be adapted to carry out other DB operations. For example, the SELECT call 502 may be constructed as an UPDATE or DELETE database operation, in order to modify or remove data object records corresponding to the search query 112 for which the user has permission to access. It should also be understood that further examples of the described system may specify different derived accessor groups for different database operations associated with data object records, in order to provide users with different permissions for different database operations (e.g., electing, updating, and deleting operations). In cases where access rights of a user could differ by operation, the derived accessor groups may be identified in the database as to which one or more operations they are applied.

With respect to FIG. 5, given a list of primitive user groups 152, the “derivedGroupsQuery” SELECT call 504 in combination with the “negativeDerivedGroups” SELECT call 506, selects all those derived accessor groups for which all primitive user groups related to the derived accessor groups via positive relationships (positiveRel) are included in the variable MY_PRIMITIVE_GROUPS for the user's list of primitive user groups 152, and for which none of the primitive user groups related via negative relationships (negativeRel) are within the variable MY_PRIMITIVE_GROUPS for the user's list of primitive user groups 152. This portion of the single SQL query results in the retrieval of a list of real derived accessor groups which are actually used (persisted in the database), for which the requesting user has membership.

It should also be noted that in this example, the “objectsQuery” SELECT call 502 that includes the received search query 112, includes a JOIN portion that limits the return of object data records to those that are stored in association with derived accessor groups determined via the “derivedGroupsQuery” SELECT call 154. This described example search query 112 is based on a simplistic object search for object data records 140 included in the previously described object table 120 of FIG. 1. It should also be understood that the “objectsQuery” SELECT call 502 that selects business objects may have any form that corresponds to the structure of the particular database to which implementations of the described examples are applied. For example, object data records may be retrieved from a plurality of different tables.

In addition, it should be appreciated that the “derivedGroupsQuery” SELECT call 504 and “negativeDerivedGroups” SELECT call 506 may be organized in an alternative manner that achieves the functionality described herein for selecting derived accessor groups based on a list of primitive user groups associated with a user. For example, an alternative “derivedGroupsQuery” SELECT call 504 and “negativeDerivedGroups” SELECT call 506 may itself select the list of primitive user groups 152 from the database based on a variable that corresponds to the particular user for which object data records are being retrieved.

In example embodiments, the definitions of the derived accessor groups are stored in the database so as to enable lookup of derived accessor group memberships from primitive user group memberships for a user in the same single SQL query that is performed to access only object data records from the database for which the derived accessor groups specify that the user has permission to access. This feature is made possible by a database schema in which the composition of derived accessor groups are represented in database form, and in a form that allows the lookup of derived accessor group memberships from primitive user group membership to be done as part of the same query as performed to retrieve business data.

Such an example minimizes database race conditions and/or the need for complex or long-term database locks, and thus enables relatively higher-speed access to user access controlled object data compared to systems that carry out user access filtration of object data post retrieval from the database. For example, an alternative approach may be to perform a full table scan of all derived groups, and perform calculations on the Boolean expression of each derived group to determine if the current user's user group (primitive) memberships meet the criteria of each derived accessor group (i.e., derived accessor). Due to parsing and calculation costs, this alternative approach would be significantly slower than the join-based approach illustrated in FIG. 5.

As illustrated in FIG. 1, all or portions of the retrieved object data records 136 may be displayed via the GUI 118 through the display device 116. In addition or alternatively, all or portions of the retrieved object data records 136 may be used by the at least one processor to carry out other functions of the application software component (which may not be displayed).

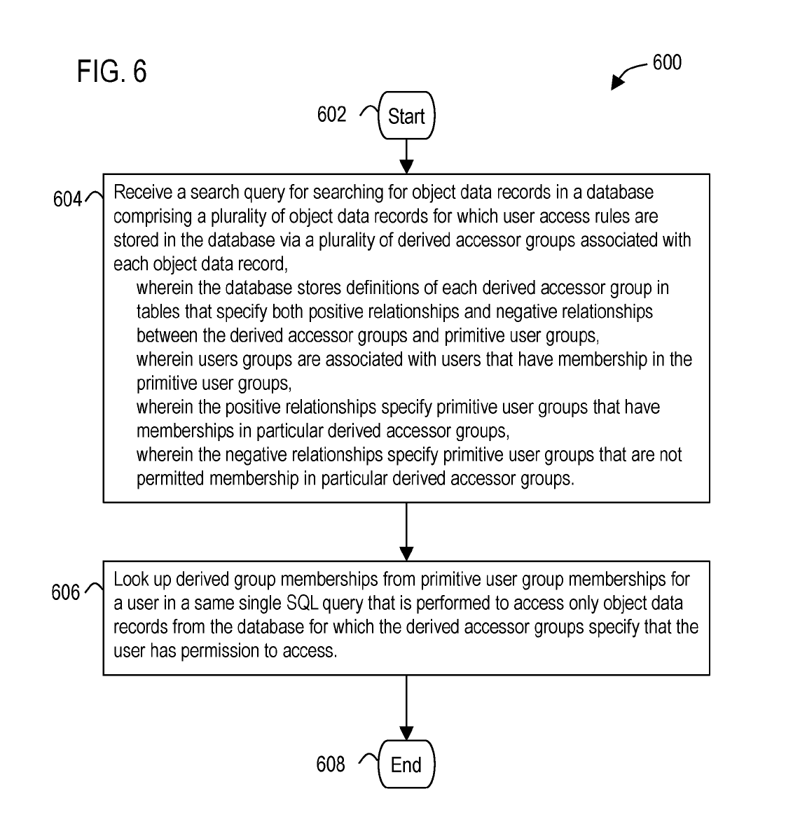

With reference now to FIG. 6, various example methodologies are illustrated and described. While the methodologies are described as being a series of acts that are performed in a sequence, it is to be understood that the methodologies may not be limited by the order of the sequence. For instance, some acts may occur in a different order than what is described herein. In addition, an act may occur concurrently with another act. Furthermore, in some instances, not all acts may be required to implement a methodology described herein.

It is important to note that while the disclosure includes a description in the context of a fully functional system and/or a series of acts, those skilled in the art will appreciate that at least portions of the mechanism of the present disclosure and/or described acts are capable of being distributed in the form of computer-executable instructions contained within non-transitory machine-usable, computer-usable, or computer-readable medium in any of a variety of forms, and that the present disclosure applies equally regardless of the particular type of instruction or data bearing medium or storage medium utilized to actually carry out the distribution. Examples of non-transitory machine usable/readable or computer usable/readable mediums include: ROMs, EPROMs, magnetic tape, floppy disks, hard disk drives, SSDs, flash memory, CDs, DVDs, and Blu-ray disks. The computer-executable instructions may include a routine, a sub-routine, programs, applications, modules, libraries, and/or the like. Still further, results of acts of the methodologies may be stored in a computer-readable medium, displayed on a display device, and/or the like.

Referring now to FIG. 6, a methodology 600 is illustrated that facilitates database-level access control using rule-based derived accessor groups. The methodology may start at 602 and may include several acts carried out through operation of at least one processor. These acts may include an act 604 of receiving a search query for searching for object data records in a database including a plurality of object data records for which user access rules are stored in the database via a plurality of derived accessor groups associated with each object data record. As discussed previously, the database stores definitions of each derived accessor group in tables that specify both positive relationships and negative relationships between the derived accessor groups and primitive user groups. Such primitive user groups are associated with users that have membership in the primitive user groups. In addition, the positive relationships specify primitive user groups that have memberships in particular derived accessor groups. Further, the negative relationships specify primitive user groups that are not permitted membership in particular derived accessor groups.

The described methodology 600 may also include an act 606 of looking up derived group memberships from primitive user group memberships for a user in a same single SQL query that is performed to access only object data records from the database for which the derived accessor groups specify that the user has permission to access. At 608 the methodology may end.

It should be appreciated that the methodology 600 may include other acts and features discussed previously with respect to the processing system 100 that are carried out through operation of the at least one processor. For example, the methodology may include an act of receiving a list of primitive user groups in which a first user has membership that is followed by retrieving from the database with the single SQL query, a set of object data records corresponding to the search query for which the first user has permissions to access. Such a single SQL query may use the received list of primitive user groups to select the set of object data records that are associated with derived groups for which: all primitive user groups related to the derived groups via a positive relationship are included in the received list of primitive user groups; and none of the primitive user groups related to the derived groups via a negative relationship are within the received list of primitive user groups.

Example embodiments of the methodology 600 may also include an act of causing a display device to provide an output including at least a portion of the retrieved set of object data records. In addition, the methodology may include an act of determining the first user via enabling the first user to provide login information.

The described embodiment may also include an act of receiving a user access rule set for at least one electronic document. As discussed previously such a rule set may include a combination of granting portions, denying portions for primitive user groups that define access to the at least one electronic document. In addition, the methodology may include generating a plurality of the derived accessor groups according to the rule set; and an act of storing the generated derived accessor groups in association with an object data record in the database that includes the at least one electronic document.

In example embodiments, the single SQL query may include a select call (or other database operation) based on the search query for object data records associated with derived accessor groups that are selected based on a further select call included in the SQL query that specifies the received list of primitive user groups. Also the database may include: a table that stores derived accessor groups; a table that stores primitive user groups; tables that store negative and positive relationships between derived accessor groups and primitive user groups; and at least one table that stores the object data records, including the at least one document in association with the plurality of derived accessor groups.

As discussed previously, acts associated with these methodologies (other than any described manual acts) may be carried out by one or more processors. Such processor(s) may be included in one or more data processing systems, for example, that execute software components (such as the described application software component) operative to cause these acts to be carried out by the one or more processors. In an example embodiment, such software components may comprise computer-executable instructions corresponding to a routine, a sub-routine, programs, applications, modules, libraries, a thread of execution, and/or the like. Further, it should be appreciated that software components may be written in and/or produced by software environments/languages/frameworks such as Java, JavaScript, Python, C, C#, C++ or any other software tool capable of producing components and graphical user interfaces configured to carry out the acts and features described herein.

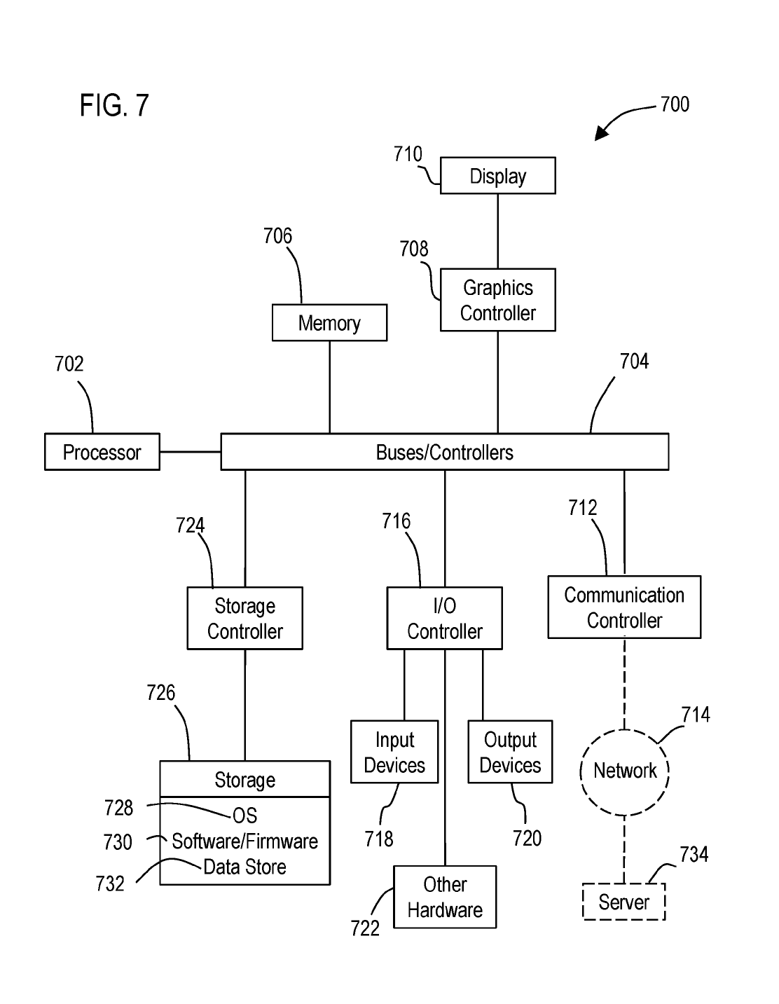

FIG. 7 illustrates a block diagram of a data processing system 700 (also referred to as a computer system) in which an embodiment can be implemented, for example, as a portion of a product system, and/or other system operatively configured by software or otherwise to perform the processes as described herein. The data processing system depicted includes at least one processor 702 (e.g., a CPU) that may be connected to one or more bridges/controllers/buses 704 (e.g., a north bridge, a south bridge). One of the buses 704, for example, may include one or more I/O buses such as a PCI Express bus. Also connected to various buses in the depicted example may include a main memory 706 (RAM) and a graphics controller 708. The graphics controller 708 may be connected to one or more display devices 710. It should also be noted that in some embodiments one or more controllers (e.g., graphics, south bridge) may be integrated with the CPU (on the same chip or die). Examples of CPU architectures include IA-32, x86-64, and ARM processor architectures.

Other peripherals connected to one or more buses may include communication controllers 712 (Ethernet controllers, WiFi controllers, cellular controllers) operative to connect to a local area network (LAN), Wide Area Network (WAN), a cellular network, and/or other wired or wireless networks 714 or communication equipment.

Further components connected to various busses may include one or more I/O controllers 716 such as USB controllers, Bluetooth controllers, and/or dedicated audio controllers (connected to speakers and/or microphones). It should also be appreciated that various peripherals may be connected to the I/O controller(s) (via various ports and connections) including input devices 718 (e.g., keyboard, mouse, pointer, touch screen, touch pad, drawing tablet, trackball, buttons, keypad, game controller, gamepad, camera, microphone, scanners, motion sensing devices that capture motion gestures), output devices 720 (e.g., printers, speakers) or any other type of device that is operative to provide inputs to or receive outputs from the data processing system. Also, it should be appreciated that many devices referred to as input devices or output devices may both provide inputs and receive outputs of communications with the data processing system. For example, the processor 702 may be integrated into a housing (such as a tablet) that includes a touch screen that serves as both an input and display device. Further, it should be appreciated that some input devices (such as a laptop) may include a plurality of different types of input devices (e.g., touch screen, touch pad, and keyboard). Also, it should be appreciated that other peripheral hardware 722 connected to the I/O controllers 716 may include any type of device, machine, or component that is configured to communicate with a data processing system.

Additional components connected to various busses may include one or more storage controllers 724 (e.g., SATA). A storage controller may be connected to a storage device 726 such as one or more storage drives and/or any associated removable media, which can be any suitable non-transitory machine usable or machine readable storage medium. Examples, include nonvolatile devices, volatile devices, read only devices, writable devices, ROMs, EPROMs, magnetic tape storage, floppy disk drives, hard disk drives, solid-state drives (SSDs), flash memory, optical disk drives (CDs, DVDs, Blu-ray), and other known optical, electrical, or magnetic storage devices drives and/or computer media. Also in some examples, a storage device such as an SSD may be connected directly to an I/O bus 704 such as a PCI Express bus.

A data processing system in accordance with an embodiment of the present disclosure may include an operating system 728, software/firmware 730, and data stores 732 (that may be stored on a storage device 726 and/or the memory 706). Such an operating system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through a pointing device such as a mouse or touch screen. The position of the cursor/pointer may be changed and/or an event, such as clicking a mouse button or touching a touch screen, may be generated to actuate a desired response. Examples of operating systems that may be used in a data processing system may include Microsoft Windows, Linux, UNIX, iOS, and Android operating systems. Also, examples of data stores include data files, data tables, relational database (e.g., Oracle, Microsoft SQL Server), database servers, or any other structure and/or device that is capable of storing data, which is retrievable by a processor.

The communication controllers 712 may be connected to the network 714 (not a part of data processing system 700), which can be any public or private data processing system network or combination of networks, as known to those of skill in the art, including the Internet. Data processing system 700 can communicate over the network 714 with one or more other data processing systems such as a server 734 (also not part of the data processing system 700). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across several data processing systems organized in a distributed system in communication with each other via a network.

Further, the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely.

In addition, it should be appreciated that data processing systems may be implemented as virtual machines in a virtual machine architecture or cloud environment. For example, the processor 702 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system may vary for particular implementations. For example, the data processing system 700 in this example may correspond to a controller, computer, workstation, server, PC, notebook computer, tablet, mobile phone, and/or any other type of apparatus/system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

Also, it should be noted that the processor described herein may be located in a server that is remote from the display and input devices described herein. In such an example, the described display device and input device may be included in a client device that communicates with the server (and/or a virtual machine executing on the server) through a wired or wireless network (which may include the Internet). In some embodiments, such a client device, for example, may execute a remote desktop application or may correspond to a portal device that carries out a remote desktop protocol with the server in order to send inputs from an input device to the server and receive visual information from the server to display through a display device. Examples of such remote desktop protocols include Teradici's PCoIP, Microsoft's RDP, and the RFB protocol. In another example, such a client device may correspond to a computer running a web browser or thin client application. Inputs from the user may be transmitted from the web browser or thin client application to be evaluated on the server, rendered by the server, and an image (or series of images) sent back to the client computer to be displayed by the web browser or thin client application. Also in some examples, the remote processor described herein may correspond to a combination of a virtual processor of a virtual machine executing in a physical processor of the server.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Also, as used herein a processor corresponds to any electronic device that is configured via hardware circuits, software, and/or firmware to process data. For example, processors described herein may correspond to one or more (or a combination) of a microprocessor, CPU, FPGA, ASIC, or any other integrated circuit (IC) or other type of circuit that is capable of processing data in a data processing system, which may have the form of a controller board, computer, server, mobile phone, and/or any other type of electronic device.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 700 may conform to any of the various current implementations and practices known in the art.

Also, it should be understood that the words or phrases used herein should be construed broadly, unless expressly limited in some examples. For example, the terms “include” and “comprise,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to describe various elements, functions, or acts, these elements, functions, or acts should not be limited by these terms. Rather these numeral adjectives are used to distinguish different elements, functions or acts from each other. For example, a first element, function, or act could be termed a second element, function, or act, and, similarly, a second element, function, or act could be termed a first element, function, or act, without departing from the scope of the present disclosure.

In addition, phrases such as “processor is configured to” carry out one or more functions or processes, may mean the processor is operatively configured to or operably configured to carry out the functions or processes via software, firmware, and/or wired circuits. For example, a processor that is configured to carry out a function/process may correspond to a processor that is executing the software/firmware, which is programmed to cause the processor to carry out the function/process and/or may correspond to a processor that has the software/firmware in a memory or storage device that is available to be executed by the processor to carry out the function/process. It should also be noted that a processor that is “configured to” carry out one or more functions or processes, may also correspond to a processor circuit particularly fabricated or “wired” to carry out the functions or processes (e.g., an ASIC or FPGA design). Further the phrase “at least one” before an element (e.g., a processor) that is configured to carry out more than one function may correspond to one or more elements (e.g., processors) that each carry out the functions and may also correspond to two or more of the elements (e.g., processors) that respectively carry out different ones of the one or more different functions.

In addition, the term “adjacent to” may mean: that an element is relatively near to but not in contact with a further element; or that the element is in contact with the further portion, unless the context clearly indicates otherwise.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

What is claimed is:

1. A system for database-level access control using rule-based derived accessor groups comprising:
a database including a plurality of object data records for which user access rules are stored in the database via a plurality of derived accessor groups associated with each object data record,
wherein the database stores definitions of each derived accessor group in tables that specify both positive relationships and negative relationships between the derived accessor groups and primitive user groups,
wherein primitive user groups are associated with users that have membership in the primitive user groups,
wherein the positive relationships specify primitive user groups that have memberships in particular derived accessor groups,
wherein the negative relationships specify primitive user groups that are not permitted membership in particular derived accessor groups,
wherein the definitions of the derived groups are stored in the database so as to enable lookup of derived group memberships from primitive user group memberships for a user in a same single SQL query that is performed to access only object data records from the database for which the derived accessor groups specify that the user has permission to access.

2. The system according to claim 1, further comprising at least one processor, configured to:
receive a search query for searching for object data records in the database,
receive a list of primitive user groups in which a first user has membership,
retrieve from the database with the single SQL query, a set of object data records corresponding to the search query for which the first user has permissions to access, which single SQL query uses the received list of primitive user groups to select the set of object data records that are associated with derived accessor groups for which:
all primitive user groups related to the derived accessor groups via a positive relationship are included in the received list of primitive user groups; and
none of the primitive user groups related to the derived accessor groups via a negative relationship are within the received list of primitive user groups.

3. The system according to claim 2, further comprising a display device, wherein the at least one processor is configured to cause the display device to provide an output including at least a portion of the retrieved set of object data records.

4. The system according to claim 3, wherein the at least one processor is configured to determine the first user via enabling the first user to provide login information.

5. The system according to claim 4, wherein the single SQL query includes a select call based on the search query for object data records associated with derived accessor groups that are selected based on a further select call included in the SQL query that specifies the received list of primitive user groups.

6. The system according to claim 5, wherein the at least one processor is configured to:
receive a user access rule set for at least one electronic document, wherein the rule set includes a combination of granting portions, denying portions for primitive user groups that define access to the at least one electronic document;
generate a plurality of the derived accessor groups according to the rule set; and
store the generated derived accessor groups in association with an object data record in the database that includes the at least one electronic document.

7. The system according to claim 6, wherein the database includes:
a table that stores derived accessor groups;
a table that stores primitive user groups;
tables that store negative and positive relationships between derived accessor groups and primitive user groups; and
at least one table that stores the object data records, including the at least one document in association with the plurality of derived accessor groups.

8. A method for database-level access control using rule-based derived accessor groups comprising:
through operation of at least one processor:
receiving a search query for searching for object data records in a database including a plurality of object data records for which user access rules are stored in the database via a plurality of derived accessor groups associated with each object data record,
wherein the database stores definitions of each derived accessor group in tables that specify both positive relationships and negative relationships between the derived accessor groups and primitive user groups,
wherein primitive user groups are associated with users that have membership in the primitive user groups,
wherein the positive relationships specify primitive user groups that have memberships in particular derived accessor groups,
wherein the negative relationships specify primitive user groups that are not permitted membership in particular derived accessor groups,
looking up derived group memberships from primitive user group memberships for a user in a same single SQL query that is performed to access only object data records from the database for which the derived accessor groups specify that the user has permission to access.

9. The method according to claim 8, further comprising through operation of the at least one processor:
receiving a list of primitive user groups in which a first user has membership,
retrieving from the database with the single SQL query, a set of object data records corresponding to the search query for which the first user has permissions to access, which single SQL query uses the received list of primitive user groups to select the set of object data records that are associated with derived groups for which:
all primitive user groups related to the derived groups via a positive relationship are included in the received list of primitive user groups; and
none of the primitive user groups related to the derived groups via a negative relationship are within the received list of primitive user groups.

10. The method according to claim 9, further comprising through operation of the at least one processor, causing the display device to provide an output including at least a portion of the retrieved set of object data records.

11. The method according to claim 10, further comprising through operation of the at least one processor, determining the first user via enabling the first user to provide login information.

12. The method according to claim 11, wherein the single SQL query includes a select call based on the search query for object data records associated with derived accessor groups that are selected based on a further select call included in the SQL query that specifies the received list of primitive user groups.

13. The method according to claim 12, further comprising through operation of the at least one processor,
receiving a user access rule set for at least one electronic document, wherein the rule set includes a combination of granting portions, denying portions for primitive user groups that define access to the at least one electronic document;
generating a plurality of the derived accessor groups according to the rule set; and
storing the generated derived accessor groups in association with an object data record in the database that includes the at least one electronic document.

14. The method according to claim 13, wherein the database includes:
a table that stores derived accessor groups;
a table that stores primitive user groups;
tables that store negative and positive relationships between derived accessor groups and primitive user groups; and
at least one table that stores the object data records, including the at least one document in association with the plurality of derived accessor groups.

15. A non-transitory computer readable medium encoded with executable instructions that when executed, cause at least one processor to carry out a method comprising:
receiving a search query for searching for object data records in a database including a plurality of object data records for which user access rules are stored in the database via a plurality of derived accessor groups associated with each object data record,
wherein the database stores definitions of each derived accessor group in tables that specify both positive relationships and negative relationships between the derived accessor groups and primitive user groups,
wherein primitive user groups are associated with users that have membership in the primitive user groups,
wherein the positive relationships specify primitive user groups that have memberships in particular derived accessor groups,
wherein the negative relationships specify primitive user groups that are not permitted membership in particular derived accessor groups,
looking up derived group memberships from primitive user group memberships for a user in a same single SQL query that is performed to access only object data records from the database for which the derived accessor groups specify that the user has permission to access.

16. The computer readable medium according to claim 15, wherein the method further comprises:
receiving a list of primitive user groups in which a first user has membership,
retrieving from the database with the single SQL query, a set of object data records corresponding to the search query for which the first user has permissions to access, which single SQL query uses the received list of primitive user groups to select the set of object data records that are associated with derived groups for which:
all primitive user groups related to the derived groups via a positive relationship are included in the received list of primitive user groups; and
none of the primitive user groups related to the derived groups via a negative relationship are within the received list of primitive user groups.

17. The computer readable medium according to claim 16, wherein the method further comprises causing the display device to provide an output including at least a portion of the retrieved set of object data records.

18. The computer readable medium according to claim 17, wherein the method further comprises determining the first user via enabling the first user to provide login information.

19. The computer readable medium according to claim 18, wherein the single SQL query includes a select call based on the search query for object data records associated with derived accessor groups that are selected based on a further select call included in the SQL query that specifies the received list of primitive user groups.

20. The computer readable medium according to claim 19, wherein the method further comprises:
receiving a user access rule set for at least one electronic document, wherein the rule set includes a combination of granting portions, denying portions for primitive user groups that define access to the at least one electronic document;
generating a plurality of the derived accessor groups according to the rule set; and
storing the generated derived accessor groups in association with an object data record in the database that includes the at least one electronic document.
